(19) United States
(12) Patent Application Publication
(10) Pub. No.: US 2006/0062459 A1
(43) Pub. Date: Mar. 23, 2006

(54) Character recognition apparatus, character recognition method, and recording medium in which character recognition program is stored

(75) Inventors: Teruka Saito, Nakai-machi (JP); Toshiya Koyama, Nakai-machi (JP); Masayoshi Sakakibara, Ebina-shi (JP); Masakazu Tateno, Nakai-machi (JP); Kei Tanaka, Minato-ku (JP); Kotaro Nakamura, Minato-ku (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/218,492

(22) Filed: Sep. 6, 2005

(30) Foreign Application Priority Data
Sep. 21, 2004 (JP) 2004-273932

(51) Int. Cl. G06K 9/00

(52) U.S. Cl. 382/181

(57) ABSTRACT

A character recognition apparatus includes: a separation processing unit that separates, into printed character portions and handwritten character portions, data of a document in which printed characters and handwritten characters are mixed; a printed character portion recognition processing unit that character-recognizes the printed character portions; and a handwritten character portion recognition processing unit that utilizes the character recognition result of the printed character portions to character-recognize the handwritten character portions.

### BACKGROUND OF THE INVENTION

1. Field of the Invention

The present invention relates to a character recognition apparatus, a character recognition method, and a recording medium in which a character recognition program is stored. In particular, the present invention relates to a character recognition apparatus, a character recognition method, and a recording medium in which a character recognition program is stored, which enable the digitalization of documents in which printed characters and handwritten characters are mixed.

2. Description of the Related Art

In recent years, documents are increasingly being circulated using electronic means such as e-mail, but there are also many instances where documents are outputted on paper. One reason for this is because it is easy to add subjoinders by hand to paper documents.

Printed characters, in which electronic information such as character codes has been outputted on paper, can be returned with high probability to digitalized electronic information by using optical character reader (OCR) software. However, conventionally a practical recognition rate cannot be obtained for character information written by hand unless strict conditions are imposed, such as grid-designation and numbers-only, which becomes a hindrance to online/offline information exchange.

### SUMMARY OF THE INVENTION

The present invention has been made in view of the above circumstances and provides a character recognition apparatus, a character recognition method, and a recording medium in which a character recognition program is stored, which enable the digitalization of documents in which printed and handwritten characters are mixed.

The character recognition apparatus of an aspect of the invention includes: a separation processing unit that separates, into printed character portions and handwritten character portions, data of a document in which printed characters and handwritten characters are mixed; a printed character portion recognition processing unit that character-recognizes the printed character portions; and a handwritten character portion recognition processing unit that utilizes the character recognition result of the printed character portions to character-recognize the handwritten character portions.

### BRIEF DESCRIPTION OF THE DRAWINGS

Embodiments of the invention will be described in detail on the basis of the following drawings, wherein:

FIG. 1 is a block diagram showing a character recognition apparatus pertaining to a first embodiment of the invention;

FIG. 2 is a plan diagram showing an example of an OCR-target document in which printed characters and handwritten characters are mixed;

FIGS. 3A and 3B are diagrams showing image data where printed character portions and handwritten character portions are separated from an image inputted to an image input unit of FIG. 1, with FIG. 3A showing image data of the printed character portion and FIG. 3B showing image data of the handwritten character portion;

FIG. 4 is an explanatory diagram showing registration content in a registration dictionary;

FIG. 5 is a diagram of an image showing results of processing by an OCR result synthesis processing unit of FIG. 1;

FIG. 6 is a block diagram showing a character recognition apparatus pertaining to a second embodiment of the invention;

FIGS. 7A and 7B are plan diagrams showing examples of OCR-target documents that are handled in the second embodiment and in which printed characters and handwritten characters are mixed, with FIG. 7A showing a fax cover sheet and FIG. 7B showing another fax cover sheet;

FIG. 8 is a block diagram showing a character recognition apparatus pertaining to a third embodiment of the invention;

FIG. 9 is a diagram showing membership applications serving as paper documents inputted to the image input unit;

FIG. 10 is an explanatory diagram showing registration content of attributes extracted by a printed character portion OCR processing unit from the membership application of FIG. 9; and

FIG. 11 is an explanatory diagram showing registration content of attributes and attribute values saved in an attribute/attribute value extraction result storage unit of FIG. 8.

### DETAILED DESCRIPTION OF THE INVENTION

### First Embodiment

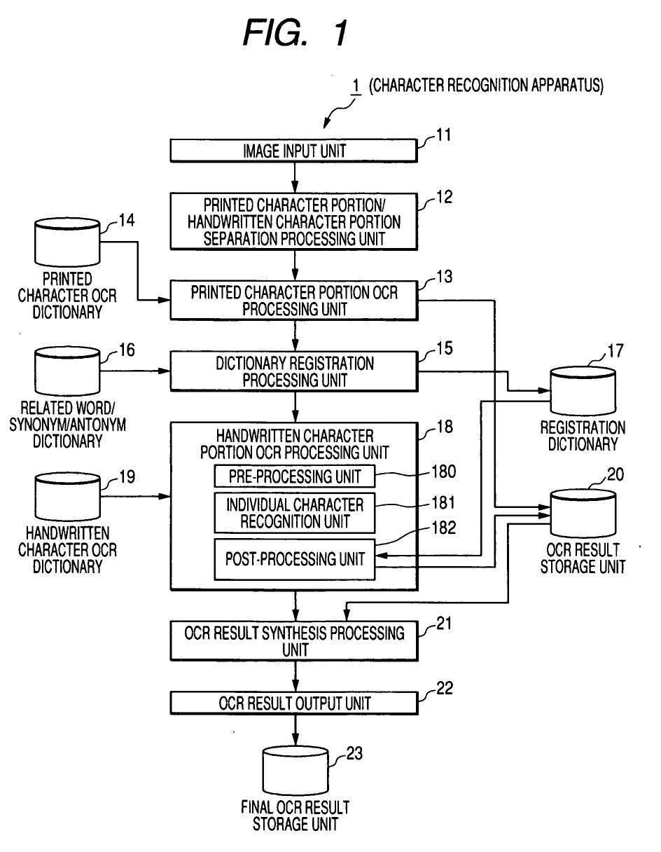

FIG. 1 shows a character recognition apparatus 1 pertaining to a first embodiment of the invention. The character recognition apparatus 1 includes: an image input unit 11 that reads a document with a scanner to input image data; a printed character portion/handwritten character portion separation processing unit 12 that separates the image data read by the image input unit 11 into a printed character portion and a handwritten character portion; a printed character portion OCR processing unit 13 that executes character recognition processing with respect to the printed character portion; a printed character OCR dictionary 14 in which a dictionary for printed character OCR is stored; a dictionary registration processing unit 15 that conducts registration processing in a registration dictionary 17; a related word/synonym/antonym dictionary 16 in which related words, synonyms and antonyms are stored; the registration dictionary 17 in which characters and word groups resulting from printed character OCR are registered; a handwritten character portion OCR processing unit 18 that executes character recognition processing with respect to the handwritten character portion using feature extraction; a handwritten character OCR dictionary 19 in which a dictionary for handwritten character OCR is stored; an OCR result storage unit 20 in which the character recognition results of the printed character portion and the handwritten character portion are stored; an OCR result synthesis processing unit 21 that synthesizes the character recognition results of the printed character portion and the handwritten character portion; an OCR result output unit 22 that outputs the result synthesized by the OCR result synthesis processing unit 21; and a final OCR result storage unit 23 that stores the content outputted from the OCR result output unit 22. An output processing unit is configured by the handwritten character portion OCR processing unit 18 and the OCR result synthesis processing unit 21.

The printed character portion/handwritten character portion separation processing unit 12 generates a histogram on the basis of the contrast of pixels in the image data and the character colors, and on the basis of this separates the image data into image data comprising a printed character portion and image data comprising a handwritten character portion. If the image data comprising the printed character portion can be identified, then image portions present at other places may be regarded as the handwritten character portion.

The printed character portion OCR processing unit 13 uses pattern matching to compare the character patterns of the cut-out printed characters with printed character patterns registered in the printed character OCR dictionary 14, and outputs the portions with the highest similarity as the recognition result of the printed character portion.

The printed character OCR dictionary 14, the related word/synonym/antonym dictionary 16, the registration dictionary 17, the handwritten character OCR dictionary 19, the OCR result storage unit 20 and the final OCR result storage unit 23 may be configured by securing regions in one or plural hard disks.

Individual characters/words (nouns/proper nouns) in the printed character portion, and synonyms (words that are similar in meaning), related words, and terms corresponding to fields of the words in the printed character portion, are registered in the registration dictionary 17 as registration dictionary information. Examples of dictionaries of terms corresponding to fields include a business terminology dictionary with respect to phrases such as “your company” and “our company”, a name dictionary with respect to words such as names, and a computer terminology dictionary with respect to “memory” and “CPU”.

The handwritten character portion OCR processing unit 18 includes: a pre-processing unit 180 that conducts pre-processing such as orientation correction and cutting out rectangular regions including characters from the image data one character at a time; an individual character recognition unit 181 that uses the handwritten character OCR dictionary 19 to conduct character recognition processing one character at a time in regard to the rectangular regions cut out by the pre-processing unit 180; and a post-processing unit 182 that uses the registration dictionary 17 to conduct language processing with strings such as word units.

The individual character recognition unit 181 compares the feature data extracted from the cut-out handwritten characters with the feature data of the characters registered in the handwritten character OCR dictionary 19, and outputs the data with the highest similarity as the recognition result of the handwritten characters.

The handwritten character portion OCR processing unit 18 uses the result of the recognition of the printed character portion by the printed character portion OCR processing unit 13 to conduct character recognition of the handwritten character portion. The following are conceivable for the processing and range of the printed characters used.
(1) Within paragraphs or character blocks, within pages, within documents, within the same document group.
(2) Determining the range of the characters used with the use frequencies and degrees of proximity between the handwritten characters and the printed characters.
(3) Conducting weighting of printed character registration information with the use frequencies and degrees of proximity between the handwritten characters and the printed characters. When used in document proofreading, there is the potential for typographical errors in regard to characters that are the closest, so portions closest in position are excluded.
(4) Because there are instances where other characters around handwritten characters are correcting the same thing, weighting is raised.
   Operation of the First Embodiment

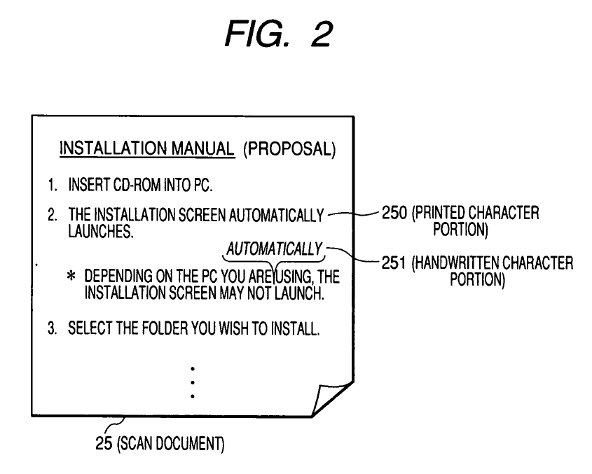

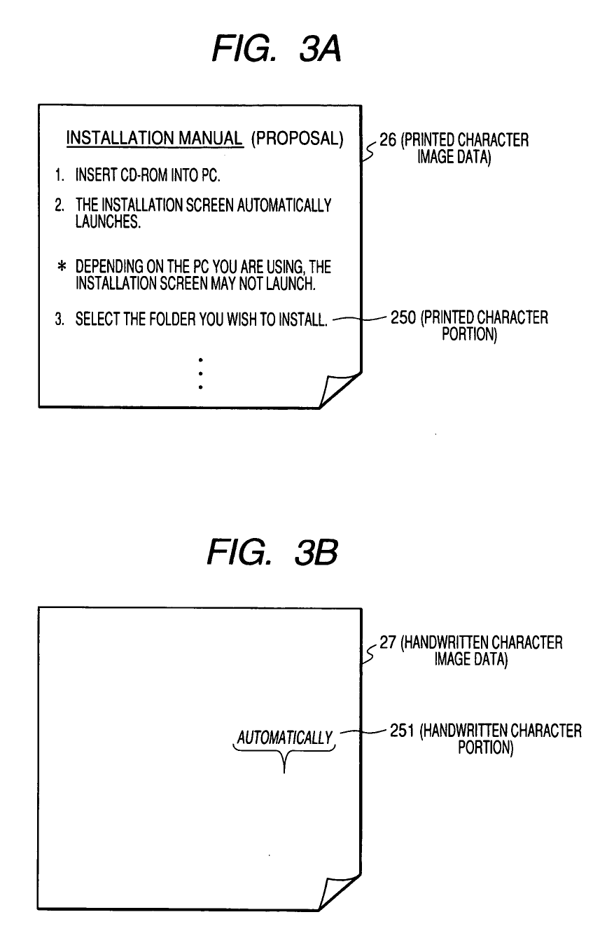

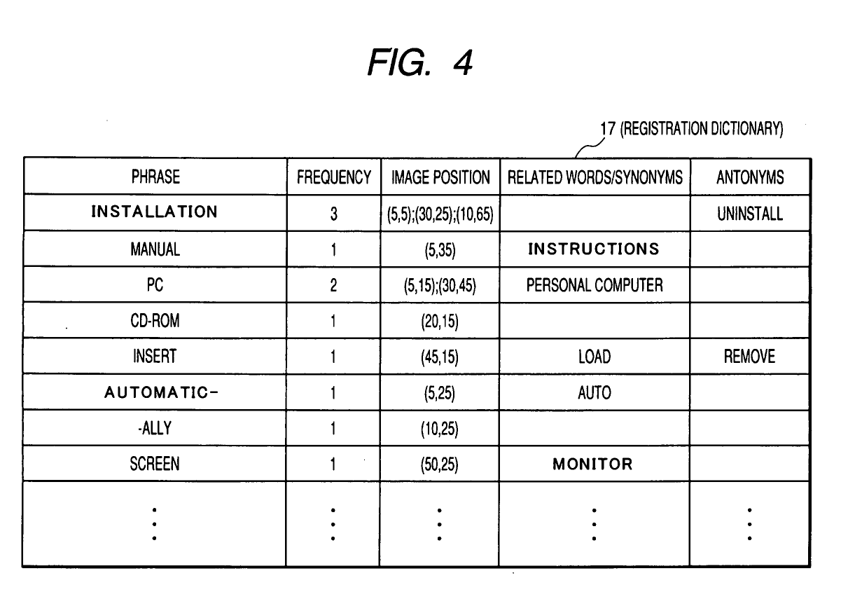

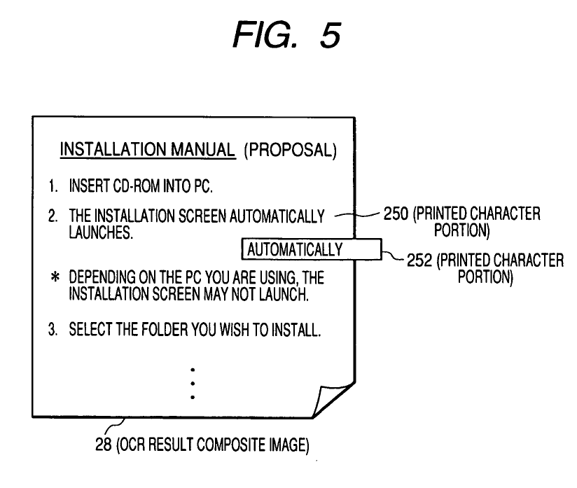

Next, the operation of the first embodiment will be described with reference to FIGS. 2 to 5. FIG. 2 shows an example of an OCR-target document 25 in which printed characters and handwritten characters are mixed. FIGS. 3A and 3B are diagrams showing recognition results in which the printed character portion and the handwritten character portion are separated from the inputted image, with FIG. 3A showing the printed character portion recognition result and FIG. 3B showing the handwritten character portion recognition result. FIG. 4 shows the registration content of the registration dictionary 17, and FIG. 5 shows the result of processing by the OCR result synthesis processing unit 21.

The scan document 25 shown in FIG. 2 is a document created and printed out by a personal computer or word processor, and the characters “AUTOMATICALLY” are, for example, added as a handwritten character portion 251 by the hand of the user to the printed character portion 250. In the present embodiment, in order to facilitate differentiation with the printed character region, a writing utensil of a color such as red that is different from the color of the printed character portion 250 is used to enter the handwritten character portion 251.

When the scan document 25 is read by the image input unit 11, the scan document 25 is converted to digital signals and outputted to the printed character portion/handwritten character portion separation processing unit 12.

The printed character portion/handwritten character portion separation processing unit 12 separates the image data of the inputted scan document 25 into printed character image data 26 including the printed character portion 250, as shown in FIG. 3A, and handwritten character image data 27 including the handwritten character portion 251, as shown in FIG. 3B.

Next, the printed character OCR processing unit 13 references the printed character OCR dictionary 14, conducts character recognition processing with respect to the printed character portion 250 of FIG. 3A, and saves the result in the OCR result storage unit 20 as the printed character recognition result.

Next, as shown in FIG. 4, the dictionary registration processing unit 15 grasps the positions (coordinates) of words and the frequency of occurrence of the words in the printed character portion 250, references the related word/synonym/antonym dictionary 16 to extract related words, synonyms and antonyms with respect to each word, and saves these in the registration dictionary 17. For example, the word “INSTALLATION” appears in three places (the first line, the third line and the seventh line) in the printed character portion 250 shown in FIG. 3A. Thus, the frequency of “INSTALLATION” is “3” and the antonym is “UNINSTALLATION”, but there is no synonym. The phrase “MANUAL” appears only once, so the frequency is “1”, and there is no antonym but there is the synonym “INSTRUCTIONS”. Dictionary registration processing is conducted in the same manner with respect to the other words.

Next, the handwritten portion OCR processing unit 18 conducts OCR processing with respect to the handwritten character portion 251 shown in FIG. 3B. Namely, after the handwritten character portion 251 has been cut out by the pre-processing unit 180, the characters “AUTOMATICALLY” are recognized one character at a time by the individual character recognition unit 181, and language processing is conducted by the post-processing unit 182. Because there are various writing styles depending on the person doing the writing, the candidate words for the handwritten characters are not limited to one. For this reason, there are ordinarily a few instances when “AUTOMATICALLY” is determined as “AUTOMATICALLY”, and plural words determined to be close are presented as recognition candidates. Table 1 shows examples of such recognition candidates. If there is only one recognition candidate, then that recognition candidate is selected.

TABLE 1

| Recognition Candidate | Reliability |
|---|---|
| AUTOMATICALLY | 30% |
| AVTOMATICALLY | 30% |
| AUTOMATICALY | 30% |
| AUTONATICALLY | 10% |

Table 1 shows a case where plural recognition candidates are indicated with respect to the content of the handwritten character portion 251. Here, “AUTOMATICALLY”, “AVTOMATICALLY”, “AUTOMATICALY” and “AUTONATICALLY” are indicated as candidate words with respect to the characters of the handwritten character portion 251. In this case, the reliability of OCR processing with respect to “AUTOMATICALLY” is calculated in regard to each word. Here, three words have the same reliability of 30%.

The post-processing unit 182 references the registration dictionary 17 to determine which of “AUTOMATICALLY”, “AVTOMATICALLY”, “AUTOMATICALY” and “AUTONATICALLY” should be selected. The post-processing unit 182 uses the occurrence frequencies of the printed characters and the closeness of the positions with respect to “AUTOMATICALLY” on the scan document 25 to calculate the reliability of each of the plural words. As shown in FIGS. 3A, 3B and 4, “AUTOMATICALLY” is present in the printed character portion 250, the frequency of occurrence of “AUTOMATICALLY” is high, and the printed characters “AUTOMATICALLY” are also present at a position close to the handwritten character portion 251, so the post-processing unit 182 raises the priority order (reliability) of “AUTOMATICALLY” of the four candidate words, and determines this as the OCR result. The determined result is saved in the OCR result storage unit 20 as the handwritten character recognition result.

Next, when the processing of the handwritten character portion OCR processing unit 18 ends, the OCR result synthesis processing unit 21 reads the OCR processing result with respect to the printed character portion 250 and the OCR processing result with respect to the handwritten character portion 251 from the OCR result storage unit 20, and synthesizes the printed character portion 250 with a printed character portion 252 as shown in FIG. 5 to obtain an OCR result composite image 28. The OCR result composite image 28 is saved in the final OCR result storage unit 23 by the OCR result output unit 22. Thus, the digitalization of the document image is completed.

### Second Embodiment

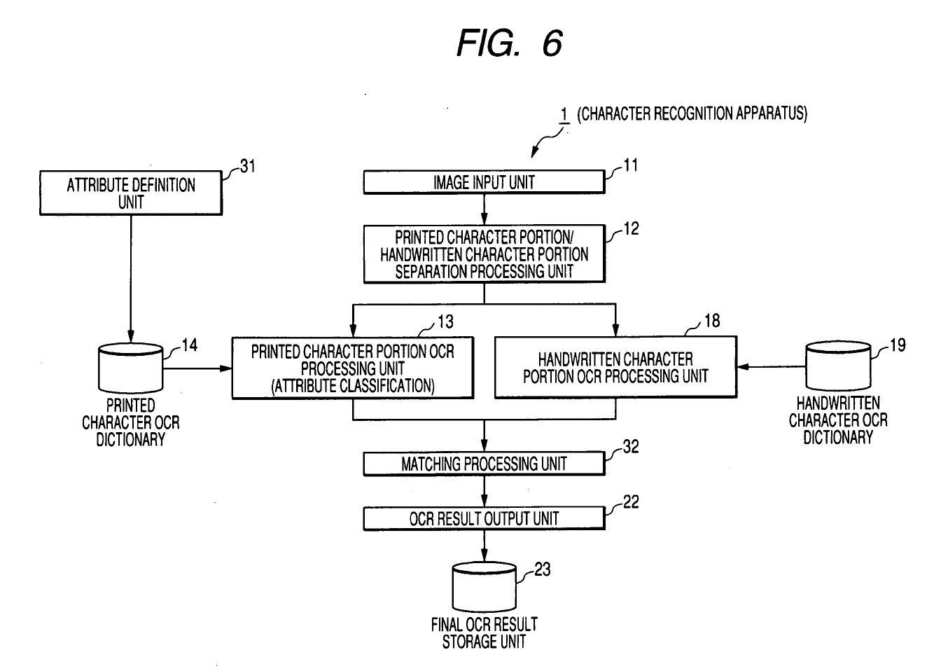

FIG. 6 shows a character recognition apparatus 1 pertaining to a second embodiment of the invention. The character recognition apparatus 1 here is similar to the character recognition apparatus 1 of the first embodiment, except that the dictionary registration processing unit 15, the related word/synonym/antonym dictionary 16, the registration dictionary 17 and the OCR result storage unit 20 are omitted, an attribute definition unit 31 that defines attributes at the time of image input by the image input unit 11 is added, and a matching processing unit 32 is disposed instead of the OCR result synthesis processing unit 21.

The attribute definition unit 31 registers, as attribute definitions in the printed character OCR dictionary 14, item names corresponding to attributes such as the destination, sender and number of pages that one wants to get out of a document serving as a reading target by an input operation of the user such as a fax cover sheet, and heading word groups such as synonyms with respect to the item names.

In the present embodiment, the printed character portion OCR processing unit 13 is configured to also output heading word groups as a word recognition result.

The matching processing unit 32 conducts matching processing of the OCR results resulting from the printed character portion OCR processing unit 13 and the handwritten character portion OCR processing unit 18.

Operation of the Second Embodiment

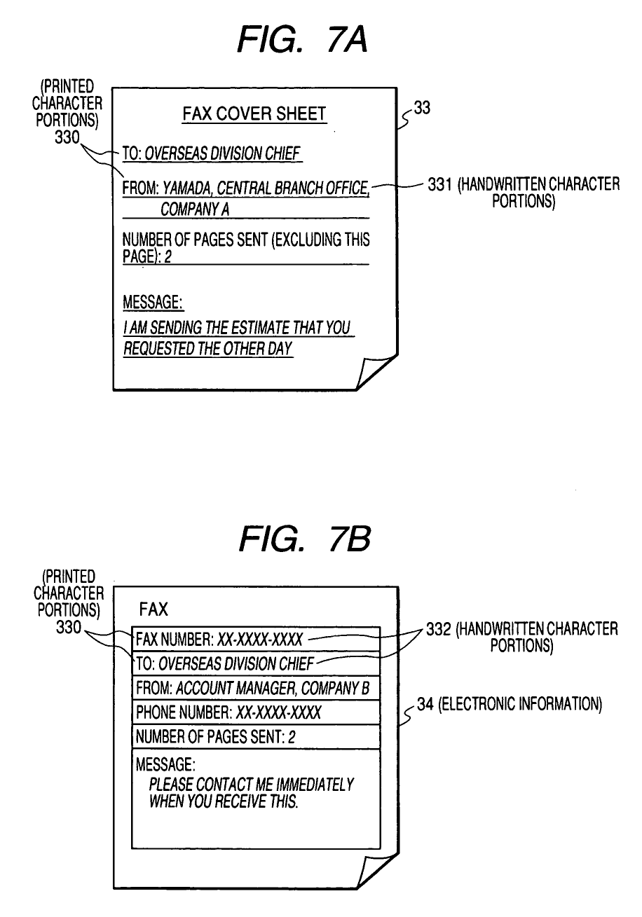

Next, the operation of the second embodiment will be described with reference to FIGS. 7A and 7B.

FIGS. 7A and 7B are diagrams showing OCR-target documents that are handled in the second embodiment and in which printed characters and handwritten characters are mixed, with FIG. 7A showing a fax cover sheet 33 serving as a paper document and FIG. 7B showing another fax cover sheet 34. The fax cover sheet 33 serving as a paper document includes: attributes resulting from printed character portions 330 including item names such as the destination, the sender, the number of pages sent, and a fax message; and handwritten character portions 331 in which an office name, the name of the sender, a number representing the number of pages sent, and sentences representing the fax message are written by hand with respect to the attributes.

The user registers, as attribute definitions in the printed character OCR dictionary 14, the attributes the user wants to get out of the fax cover sheet 33 shown in FIG. 7A and the heading word groups such as synonyms, as shown in Table 2. Thus, “Attribute: Destination” is allocated to “TO” of the fax cover sheet 33 of FIG. 7A and the fax cover sheet 34 of FIG. 7B.

TABLE 2

| Attribute: Destination | Attribute: Sender | Attribute: Number of Pages |
|---|---|---|
| TO | FROM | NUMBER OF PAGES SENT |

Next, the fax cover sheet 33 is scanned with a scanner and inputted by the image input unit 11. The printed character portion/handwritten character portion separation processing unit 12 separates the inputted image data of the fax cover sheet 33 into the printed character portions 330 and the handwritten character portions 331 as described in the first embodiment. The printed character portion OCR processing unit 13 references the printed character OCR dictionary 14 and conducts OCR processing of the printed character portions 330, and the handwritten character portion OCR processing unit 18 references the handwritten character OCR dictionary 19 and conducts OCR processing of the handwritten character portions 331.

The matching processing unit 32 conducts matching processing of the OCR results resulting from the printed character portion OCR processing unit 13 and the handwritten character portion OCR processing unit 18. In this processing, the OCR result resulting from the handwritten character portion OCR processing unit 18 is matched with the registered heading word group, and the attribute closest to the entry position is allocated to the OCR result resulting from the handwritten character portion OCR processing unit 18. The position information of the handwritten character portions 331 on the fax cover sheet 33 is also saved. Next, the positions of the printed character portions 330 and the handwritten character portions 331 are matched from the positional relations between the printed character portions 330 and the handwritten character portions 331. In the fax cover sheet 33 of FIG. 7A, “TO”, which is the printed character OCR result, and “OVERSEAS DIVISION CHIEF”, which is the handwritten character OCR result, are matched. In this case, simply the printed characters to which attributes have been given may be matched.

Finally, the OCR result output unit 22 saves, in the final OCR result storage unit 23, the attributes that have become a group (TO, FROM, etc.), the attribute values (OVERSEAS DIVISION CHIEF, YAMADA, CENTRAL BRANCH OFFICE, COMPANY A, etc.), and the electronic information in which the attributes and attribute values have been printed as the printed character portions 330 and 331.

### Third Embodiment

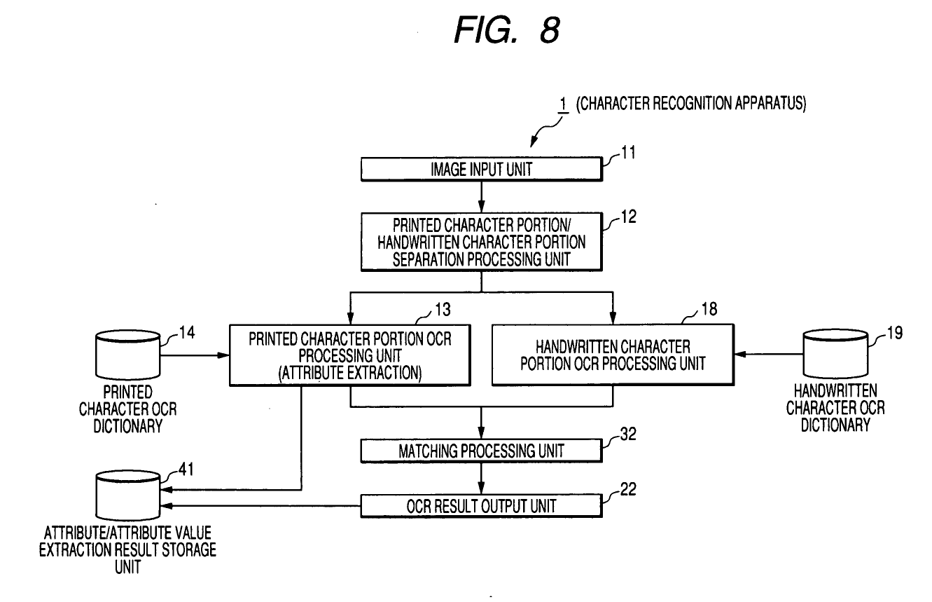

FIG. 8 shows a character recognition apparatus 1 pertaining to a third embodiment of the invention. The character recognition apparatus 1 here is similar to the character recognition apparatus 1 of the second embodiment, except that attribute definition is not conducted, an attribute/attribute value extraction result storage unit 41 is disposed instead of the final OCR result storage unit 23, and the OCR results resulting from the printed character portion OCR processing unit 13 and the handwritten character portion OCR processing unit 18 are saved in the attribute/attribute value extraction result storage unit 41.

In the present embodiment, the printed character portion OCR processing unit 13 counts the extracted words, and registers the words with the highest frequency as attributes in the attribute/attribute value extraction result storage unit 41.

Operation of the Third Embodiment

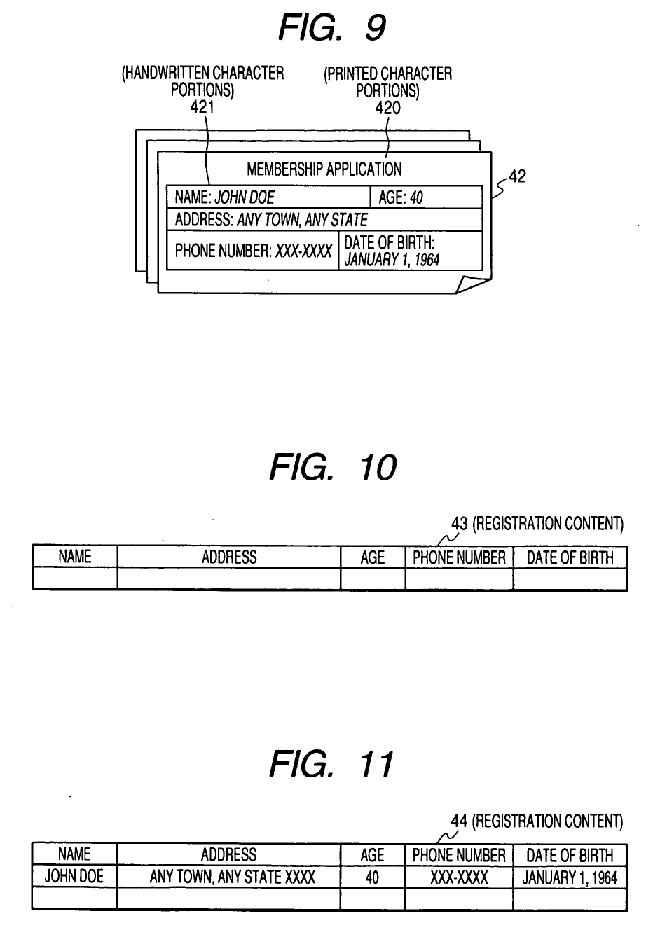

Next, the operation of the third embodiment will be described with reference to FIGS. 9 to 11.

FIG. 9 shows membership applications 42 serving as the documents inputted to the image input unit 11. FIG. 10 shows an example of the attributes extracted by the printed character portion OCR processing unit 13 from the membership application of FIG. 9. FIG. 11 shows an example of the attributes and attribute values saved in the attribute/attribute value extraction result storage unit 41.

In the membership application 42, a specific printing form is formed by ruled lines with printed character portions 420 resulting from printed characters, and a name and address are entered by hand as handwritten character portions 421 in the printing form. A plural number of sheets in which the names are different are prepared as the membership applications 42.

First, the plural membership applications 42 are inputted to the image input unit 11 by being successively scanned with a scanner. Next, the printed character portion/handwritten character portion separation processing unit 12 separates the image data into the printed character portions 420 and the handwritten character portions 421 as described in the first embodiment. The printed character portion OCR processing unit 13 references the printed character OCR dictionary 14 and conducts OCR processing of the printed character portions 420, and the handwritten character portion OCR processing unit 18 references the handwritten character OCR dictionary 19 and conducts OCR processing of the handwritten character portions 421.

In the processing of the printed character portion OCR processing unit 13, the extracted words are counted, and registration content 43 in which the words whose ratio with respect to the total number of membership applications 42 is large, i.e., the words whose frequency is high, is used as the attributes registered in the attribute/attribute value extraction result storage unit 41 as shown in FIG. 10. The positions of the words on the membership applications 42 are also saved in the attribute/attribute value extraction result storage unit 41 for each membership application 42. It will be noted that the attributes may also be registered in advance in the attribute/attribute value extraction result storage unit 41.

Next, the printed character portions 420 and the handwritten character portions 421 are matched by the matching processing unit 32 from the distance between the printed character portions 420 and the handwritten character portions 421 and the positional relations between the printed character portions 420 above, below, right and left of the handwritten character portions 421. Here, the matching follows a rule in which the printed character portions 420 and the handwritten character portions 421 in the same ruled lines, frames and base colors are matched. In order to avoid double association, the printed character portions 420 that have been associated once are excluded from the list. Finally, the attributes and attribute values that have become a group are saved as registration content 44 in the form shown in FIG. 11 by the OCR result output unit 22 in the attribute/attribute value extraction result storage unit 41.

In the third embodiment, the membership applications 42 were described as examples of documents, but the present invention is not limited to the membership applications 42 and can also be applied to all documents having the same form and having printed character portions and handwritten character portions.

### Other Embodiments

The present invention is not limited to the preceding embodiments, and may be altered within a range that does not change the gist of the invention. The constituent elements of the various embodiments may also be optionally combined.

As described above, some embodiments of the invention are outlined below.

In one embodiment of the invention, the character recognition apparatus comprises: a separation processing unit that separates, into printed character portions and handwritten character portions, data of a document in which printed characters and handwritten characters are mixed; a printed character portion recognition processing unit that character-recognizes the printed character portions; and a handwritten character portion recognition processing unit that utilizes the character recognition result of the printed character portions to character-recognize the handwritten character portions.

In another embodiment of the invention, the character recognition apparatus comprises: a separation processing unit that separates, into printed character portions and handwritten character portions, data of a document in which printed characters and handwritten characters are mixed; a printed character portion recognition processing unit that character-recognizes the printed character portions; a handwritten character portion recognition processing unit that utilizes the character recognition result of the printed character portions to character-recognize the handwritten character portions; and a synthesis processing unit that synthesizes the character recognition result of the printed character portions and the character recognition result of the handwritten character portions.

By synthesizing and outputting the character recognition result of the printed character portions and the character recognition result of the handwritten character portions, data of a document in which printed characters and handwritten characters are mixed can be converted to electronic data.

In another embodiment of the invention, the character recognition apparatus comprises: a separation processing unit that separates, into printed character portions and handwritten character portions, data of a document in which printed characters and handwritten characters are mixed; a printed character portion recognition processing unit that references a dictionary relating to attributes to character-recognize the printed character portions; a handwritten character portion recognition processing unit that character-recognizes the handwritten character portions; and a matching processing unit that correlates strings in the handwritten character portions corresponding to the attributes of the character recognition result of the printed character portions.

By referencing the dictionary relating to attributes, attributes included in the printed character portions in the data of the document can be recognized, and the handwritten character portions corresponding to the attributes can be matched.

In still another embodiment of the invention, the character recognition apparatus comprises: a separation processing unit that separates, into printed character portions and handwritten character portions, data of plural documents in which printed characters and handwritten characters are mixed; a printed character portion recognition processing unit that character-recognizes the printed character portions of the data of the plural documents and stores, as attributes, strings whose frequency is high; a handwritten character portion recognition processing unit that character-recognizes the handwritten character portions; and a matching processing unit that correlates strings in the handwritten character portions corresponding to the attributes of the character recognition result of the printed character portions.

Even without using a dictionary relating to attributes, strings whose frequency is high in the data of the plural documents may be used as attributes, whereby the handwritten character portions corresponding to the attributes can be matched.

In still another embodiment of the invention, the character recognition method comprises: separating, into printed character portions and handwritten character portions, data of a document in which printed characters and handwritten characters are mixed; character-recognizing the printed character portions; and utilizing the character recognition result of the printed character portions to character-recognize the handwritten character portions.

In still yet another embodiment of the invention, the character recognition method comprises: separating, into printed character portions and handwritten character portions, data of a document in which printed characters and handwritten characters are mixed; referencing a dictionary relating to attributes to character-recognize the printed character portions; character-recognizing the handwritten character portions; and correlating strings in the handwritten character portions corresponding to the attributes of the character recognition result of the printed character portions.

In another embodiment of the invention, the character recognition method comprises: separating, into printed character portions and handwritten character portions, data of plural documents in which printed characters and handwritten characters are mixed; character-recognizing the printed character portions of the data of the plural documents and storing, as attributes, strings whose frequency is high; character-recognizing the handwritten character portions; and correlating strings in the handwritten character portions corresponding to the attributes of the character recognition result of the printed character portions.

In another embodiment of the invention, there is provided a recording medium readable by a computer, the recording medium storing a character recognition program executable by the computer to perform a function for recognizing characters, the function comprising: separating, into printed character portions and handwritten character portions, data of a document in which printed characters and handwritten characters are mixed; character-recognizing the printed character portions; and utilizing the character recognition result of the printed character portions to character-recognize the handwritten character portions.

In yet another embodiment of the invention, there is provided a recording medium readable by a computer, the recording medium storing a character recognition program executable by the computer to perform a function for recognizing characters, the function comprising: separating, into printed character portions and handwritten character portions, data of a document in which printed characters and handwritten characters are mixed; referencing a dictionary relating to attributes to character-recognize the printed character portions; character-recognizing the handwritten character portions; and correlating strings in the handwritten character portions corresponding to the attributes of the character recognition result of the printed character portions.

In still another embodiment of the invention, there is provided a recording medium readable by a computer, the recording medium storing a character recognition program executable by the computer to perform a function for recognizing characters, the function comprising: separating, into printed character portions and handwritten character portions, data of plural documents in which printed characters and handwritten characters are mixed; character-recognizing the printed character portions of the data of the plural documents and storing, as attributes, strings whose frequency is high; character-recognizing the handwritten character portions; and correlating strings in the handwritten character portions corresponding to the attributes of the character recognition result of the printed character portions.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-273932 filed on Sep. 21, 2004 including specification, claims, drawings and abstract is incorporated herein by reference in its entirety.

FIG. 1

1 CHARACTER RECOGNITION APPARATUS
11 IMAGE INPUT UNIT
12 PRINTED CHARACTER PORTION/HANDWRITTEN CHARACTER PORTION SEPARATION PROCESSING UNIT
13 PRINTED CHARACTER PORTION OCR PROCESSING UNIT
14 PRINTED CHARACTER OCR DICTIONARY
15 DICTIONARY REGISTRATION PROCESSING UNIT
16 RELATED WORD/SYNONYM/ANTONYM DICTIONARY
17 REGISTRATION DICTIONARY
18 HANDWRITTEN CHARACTER PORTION OCR PROCESSING UNIT
180 PRE-PROCESSING UNIT
181 INDIVIDUAL CHARACTER RECOGNITION UNIT
182 POST-PROCESSING UNIT
19 HANDWRITTEN CHARACTER OCR DICTIONARY
20 OCR RESULT STORAGE UNIT
21 OCR RESULT SYNTHESIS PROCESSING UNIT
22 OCR RESULT OUTPUT UNIT
23 FINAL OCR RESULT STORAGE UNIT
   FIG. 2
INSTALLATION MANUAL (PROPOSAL)
1. INSERT CD-ROM INTO PC.
2. THE INSTALLATION SCREEN AUTOMATICALLY LAUNCHES. *DEPENDING ON THE PC YOU ARE USING, THE INSTALLATION SCREEN MAY NOT LAUNCH.
3. ELECT THE FOLDER YOU WISH TO INSTALL.
250 PRINTED CHARACTER PORTION
251 HANDWRITTEN CHARACTER PORTION
AUTOMATICALLY
25 SCAN DOCUMENT
   FIG. 3A
INSTALLATION MANUAL (PROPOSAL)
1. INSERT CD-ROM INTO PC.
2. THE INSTALLATION SCREEN AUTOMATICALLY LAUNCHES. *DEPENDING ON THE PC YOU ARE USING, THE INSTALLATION SCREEN MAY NOT LAUNCH.
3. SELECT THE FOLDER YOU WISH TO INSTALL.
26 PRINTED CHARACTER IMAGE DATA
250 PRINTED CHARACTER PORTION
   FIG. 3B
27 HANDWRITTEN CHARACTER IMAGE DATA
251 HANDWRITTEN CHARACTER PORTION
AUTOMATICALLY
   FIG. 4
PHRASE

INSTALLATION

MANUAL

PC

CD-ROM

INSERT

AUTOMATICALLY

SCREEN
FREQUENCY
IMAGE POSTION
RELATED WORDS/SYNONYMS

INSTRUCTIONS

PERSONAL COMPUTER

LOAD

AUTO

MONITOR
ANTONYMS

UNINSTALL

REMOVE
17 REGISTRATION DICTIONARY
   FIG. 5
INSTALLATION MANUAL (PROPOSAL)
1. INSERT CD-ROM INTO PC.
2. THE INSTALLATION SCREEN AUTOMATICALLY LAUNCHES. *DEPENDING ON THE PC YOU ARE USING, THE INSTALLATION SCREEN MAY NOT LAUNCH.
3. SELECT THE FOLDER YOU WISH TO INSTALL.
250 PRINTED CHARACTER PORTION
252 PRINTED CHARACTER PORTION
AUTOMATICALLY
28 OCR RESULT COMPOSITE IMAGE
   FIG. 6
1 CHARACTER RECOGNITION APPARATUS
11 IMAGE INPUT UNIT
12 PRINTED CHARACTER PORTION/HANDWRITTEN CHARACTER PORTION SEPARATION PROCESSING UNIT
13 PRINTED CHARACTER PORTION OCR PROCESSING UNIT (ATTRIBUTE CLASSIFICATION)
14 PRINTED CHARACTER OCR DICTIONARY
18 HANDWRITTEN CHARACTER PORTION OCR PROCESSING UNIT
19 HANDWRITTEN CHARACTER OCR DICTIONARY
22 OCR RESULT OUTPUT UNIT
23 FINAL OCR RESULT STORAGE UNIT
31 ATTRIBUTE DEFINITION UNIT
32 MATCHING PROCESSING UNIT
   FIG. 7
FAX COVER SHEET
TO: OVERSEAS DIVISION CHIEF
FROM: YAMADA, CENTRAL BRANCH OFFICE, COMPANY A
NUMBER OF PAGES SENT (EXCLUDING THIS PAGE): 2
MESSAGE: I AM SENDING THE ESTIMATE THAT YOU REQUESTED THE OTHER DAY
330 PRINTED CHARACTER PORTIONS
331 HANDWRITTEN CHARACTER PORTIONS
   FIG. 7B
FAX NUMBER: XX-XXXX-XXXX
TO: OVERSEAS DIVISION CHIEF
FROM: ACCOUNT MANAGER, COMPANY B
PHONE NUMBER: XX-XXXX-XXXX
NUMBER OF PAGES SENT: 2
MESSAGE: PLEASE CONTACT ME IMMEDIATELY WHEN YOU RECEIVE THIS.
330 PRINTED CHARACTER PORTIONS
332 HANDWRITTEN CHARACTER PORTIONS
34 ELECTRONIC INFORMATION
   FIG. 8
1 CHARACTER RECOGNITION APPARATUS
11 IMAGE INPUT UNIT
12 PRINTED CHARACTER PORTION/HANDWRITTEN CHARACTER PORTION SEPARATION PROCESSING UNIT
13 PRINTED CHARACTER PORTION OCR PROCESSING UNIT (ATTRIBUTE EXTRACTION)
14 PRINTED CHARACTER OCR DICTIONARY
18 HANDWRITTEN CHARACTER PORTION OCR PROCESSING UNIT
19 HANDWRITTEN CHARACTER OCR DICTIONARY
22 OCR RESULT OUTPUT UNIT
32 MATCHING PROCESSING UNIT
41 ATTRIBUTE/ATTRIBUTE VALUE EXTRACTION RESULT STORAGE UNIT
   FIG. 9
MEMBERSHIP APPLICATION
NAME: JOHN DOE
AGE: 40
ADDRESS: ANY TOWN, ANY STATE
PHONE NUMBER: XXX-XXXX
DATE OF BIRTH: JAN. 1, 1964
420 PRINTED CHARACTER PORTIONS
421 HANDWRITTEN CHARACTER PORTIONS
   FIG. 10
43 REGISTRATION CONTENT
NAME
ADDRESS
AGE
PHONE NUMBER
DATE OF BIRTH
   FIG. 11
44 REGISTRATION CONTENT
NAME

JOHN DOE
ADDRESS

ANY TOWN, ANY STATE
AGE

40
PHONE NUMBER

XXX-XXXX
DATE OF BIRTH

JAN. 1, 1964

What is claimed is:

1. A character recognition apparatus comprising:
a separation processing unit that separates, into printed character portions and handwritten character portions, data of a document in which printed characters and handwritten characters are mixed;
a printed character portion recognition processing unit that character-recognizes the printed character portions; and
a handwritten character portion recognition processing unit that utilizes the character recognition result of the printed character portions to character-recognize the handwritten character portions.

2. The character recognition apparatus of claim 1, wherein the handwritten character portion recognition processing unit determines a range to be used on the basis of the use frequencies or positions of characters in the printed character portions, and utilizes the character recognition result of the printed character portions in the determined range to character-recognize the handwritten character portions.

3. The character recognition apparatus of claim 1, wherein the handwritten character portion recognition processing unit utilizes the character recognition result of the printed character portions, and related words, synonyms and antonyms, to character-recognize the handwritten character portions.

4. The character recognition apparatus of claim 1, wherein the handwritten character portion recognition processing unit utilizes the character recognition result of the printed character portions by adding weight in accordance with the use frequencies or positions of characters in the printed character portions to character-recognize the handwritten character portions.

5. The character recognition apparatus of claim 1, further comprising a synthesis processing unit that synthesizes the character recognition result of the printed character portions and the character recognition result of the handwritten character portions.

6. A character recognition apparatus comprising:
a separation processing unit that separates, into printed character portions and handwritten character portions, data of a document in which printed characters and handwritten characters are mixed;
a printed character portion recognition processing unit that references a dictionary relating to attributes to character-recognize the printed character portions;
a handwritten character portion recognition processing unit that character-recognizes the handwritten character portions; and
a matching processing unit that correlates strings in the handwritten character portions corresponding to the attributes of the character recognition result of the printed character portions.

7. A character recognition apparatus comprising:
a separation processing unit that separates, into printed character portions and handwritten character portions, data of plural documents in which printed characters and handwritten characters are mixed;
a printed character portion recognition processing unit that character-recognizes the printed character portions of the data of the plural documents and stores, as attributes, strings whose frequency is high;
a handwritten character portion recognition processing unit that character-recognizes the handwritten character portions; and
a matching processing unit that correlates strings in the handwritten character portions corresponding to the attributes of the character recognition result of the printed character portions.

8. The character recognition apparatus of claim 6, wherein the matching processing unit associates and stores the character recognition result of the handwritten character portions with printed characters positioned around the handwritten character portions of the character recognition result of the printed character portions.

9. The character recognition apparatus of claim 7, wherein the matching processing unit associates and stores the character recognition result of the handwritten character portions with printed characters positioned around the handwritten character portions of the character recognition result of the printed character portions.

10. The character recognition apparatus of claim 6, wherein the matching processing unit associates and stores the character recognition result of the handwritten character portions with printed characters positioned above, below, left or right of the handwritten character portions of the character recognition result of the printed character portions.

11. The character recognition apparatus of claim 7, wherein the matching processing unit associates and stores the character recognition result of the handwritten character portions with printed characters positioned above, below, left or right of the handwritten character portions of the character recognition result of the printed character portions.

12. A character recognition method comprising:
separating, into printed character portions and handwritten character portions, data of a document in which printed characters and handwritten characters are mixed;
character-recognizing the printed character portions; and
utilizing the character recognition result of the printed character portions to character-recognize the handwritten character portions.

13. A character recognition method comprising:
separating, into printed character portions and handwritten character portions, data of a document in which printed characters and handwritten characters are mixed;
referencing a dictionary relating to attributes to character-recognize the printed character portions;
character-recognizing the handwritten character portions; and
correlating strings in the handwritten character portions corresponding to the attributes of the character recognition result of the printed character portions.

14. A character recognition method comprising:
separating, into printed character portions and handwritten character portions, data of plural documents in which printed characters and handwritten characters are mixed;
character-recognizing the printed character portions of the data of the plural documents and storing, as attributes, strings whose frequency is high;
character-recognizing the handwritten character portions; and
correlating strings in the handwritten character portions corresponding to the attributes of the character recognition result of the printed character portions.

15. A recording medium readable by a computer, the recording medium storing a character recognition program executable by the computer to perform a function for recognizing characters, the function comprising:
separating, into printed character portions and handwritten character portions, data of a document in which printed characters and handwritten characters are mixed;
character-recognizing the printed character portions; and
utilizing the character recognition result of the printed character portions to character-recognize the handwritten character portions.

16. A recording medium readable by a computer, the recording medium storing a character recognition program executable by the computer to perform a function for recognizing characters, the function comprising:
separating, into printed character portions and handwritten character portions, data of a document in which printed characters and handwritten characters are mixed;
referencing a dictionary relating to attributes to character-recognize the printed character portions;
character-recognizing the handwritten character portions; and
correlating strings in the handwritten character portions corresponding to the attributes of the character recognition result of the printed character portions.

17. A recording medium readable by a computer, the recording medium storing a character recognition program executable by the computer to perform a function for recognizing characters, the function comprising:
separating, into printed character portions and handwritten character portions, data of plural documents in which printed characters and handwritten characters are mixed;
character-recognizing the printed character portions of the data of the plural documents and storing, as attributes, strings whose frequency is high;
character-recognizing the handwritten character portions; and
correlating strings in the handwritten character portions corresponding to the attributes of the character recognition result of the printed character portions.
